(19) United States
(12) Patent Application Publication
(10) Pub. No.: US 2004/0057546 A1
(43) Pub. Date: Mar. 25, 2004

(54) Variable phase-shifting circuit, phase interpolator incorporating it, and digital frequency synthesizer incorporating such an interpolator

(76) Inventors: Franck Badets, Meylan (FR); Didier Belot, Rives (FR)

Correspondence Address: DOCKET CLERK, P.O. DRAWER 800889, DALLAS, TX, 75380, US

(21) Appl. No.: 10/603,579

(22) Filed: Jun. 25, 2003

(30) Foreign Application Priority Data
Jun. 25, 2002 (FR) 0207856

(51) Int. Cl. H04L 7/00; H04L 25/00

(52) U.S. Cl. 375/371

(57) ABSTRACT

A variable phase-shifting circuit comprises an input for receiving an input signal having a specified oscillation frequency, an output for delivering an output signal having the same oscillation frequency and having a variable phase shift with respect to the input signal, and at least a control input. The control input receives a control signal that controls the phase shift of the output signal with respect to the said input signal. The circuit includes a synchronized oscillator with a synchronization input coupled to the input of the phase-shifting circuit for receiving the input signal, at least an output coupled to the output of the phase-shifting circuit for delivering the output signal. The synchronized oscillator has a variable free-running oscillation frequency which is controlled by the control signal. Application is proposed to phase interpolation and digital frequency synthesis.

### BACKGROUND OF THE INVENTION

1. Technical Field

The present invention relates to the field of digital frequency synthesis. More specifically, it relates to a variable phase shifting circuit, a phase interpolator incorporating it, and a digital frequency synthesizer incorporating such a phase interpolator.

However, the applications of the phase-shifting circuit of the invention are not restricted to the case of phase interpolators, and extend widely beyond the field of frequency synthesis. This phase-shifting circuit may, in fact, find applications in many other fields of the electronics.

Phase interpolators offer a solution to the problem of eliminating spurious frequencies in the spectrum of a signal synthesized using a phase accumulator for instance. These spurious frequencies originate from the periodicity of the jitter that inherently affects such a signal.

2. Related Art

A first known phase interpolator architecture uses a capacitor with a specified value C, charged by a current source delivering a current of specified value I, and a comparator that switches when the voltage at the capacitor terminals exceeds a threshold voltage of specified value V. By varying the charge current, the capacitor value, or the threshold voltage, it is possible to change the instant t at which the comparator switches. The relationship linking these four values being: . In the article “A Low-Power Direct Digital Synthesizer Using a Self-Adjusting Phase Interpolation Technique”, H. Nosaka, Y. Yamaguchi, A. Yamagishi, H. Fukuyama and M. Muraguchi, IEEE Journal of Solid State Circuits, Vol. 36, No 8, August 2001, the instant of switching is thus set by placing a variable number of elementary current sources in parallel.

A second known architecture, called an “Anti-Jitter Circuit” uses a first fixed-width pulse generator controlled by the signal from the phase accumulator, a charge pump that charges and discharges a capacitor, a comparator, and a second pulse generator controlled on the falling edges of the comparator. Since the duration of the pulse set by the signal from the phase accumulator is fixed, the instants of occurrence of the output pulse are equidistant, even if the edges at its input are not. The period thus obtained corresponds to the average period of the signal from the phase accumulator A third known architecture consists in using a clock generator with N phases, where N is a whole number, at the average frequency Fout of the phase accumulator overflow bit. At each overflow of the phase accumulator, that one of the N phases is chosen that enables the average period 1/Fout of the accumulator overflow bit to be matched as closely as possible. An example of such an architecture is given in the article “A Virtual Clock Enhancement Method for DDS Using -an Analog Delay Line”, R. Richter, H. J. Jentschel, IEEE Journal of Solid State Circuits, Vol. 36, No 7, July 2001. The generator includes a loop of delay elements called a Delay-Locked Loop or DLL. Each delay element consists of an inverter.

The efficiency of this third architecture depends on the number of clock generator phases. A large number of phases is required to achieve a satisfactory rejection of spurious frequencies. However, the number of inverters is limited in practice, since, denoting the delay introduced by each inverter as D, the following constraint must be respected:

N.D=Fclk (1)

where Fclk designates the clock signal frequency that regulates the rate of the phase accumulator.

The invention aims to suggest an alternative to this state of the art by proposing a variable phase-shifting circuit offering characteristics suited to its use in a phase interpolator based on a technique of the type of the aforesaid third architecture.

### SUMMARY OF THE INVENTION

A first aspect of the invention thus relates to a variable phase-shifting circuit comprising an input for receiving an input signal with a specified oscillation frequency, an output for delivering an output signal having said specified oscillation frequency and having a variable phase shift with respect to said input signal, and at least one control input for receiving a control signal that controls said phase shift. The variable phase-shifting circuit comprises a synchronized oscillator having at least one synchronization input coupled to said input of the variable phase-shifting circuit for receiving said input signal, and at least one output coupled to said output of the variable phase-shifting circuit for delivering said output signal. The synchronized oscillator has a variable free-running oscillation frequency which is controlled by said control signal.

One advantage of such a circuit is that the phase-shift that it introduces can be as small as required. Moreover, the fact that the phase-shift can be varied and that this variation can be as small as required enables the presence of a large number of delay elements to be “simulated” from a small number of such variable phase-shifting circuits.

Another advantage arises from the speed of phase acquisition when the control signal is altered, thus making such variable phase-shifting circuits good candidates for phase interpolators.

A second aspect of the invention relates to a phase interpolator comprising:

a signal output which delivers an output signal;

at least one data input for receiving a digital input value coded in a given number P of bits, where P is an integer, representing the difference between an actual instant of switching of a pulse of a signal to be interpolated and a desired instant of switching of said output signal;

a given number N1 of first variable phase-shifting circuits, where N1 is an integer strictly greater than one, each including an input which receives an input signal having the frequency of a specified reference signal, the input signals received by the said respective inputs of said N1 variable phase-shifting circuits being respectively phase-shifted by 360°/N1, each variable phase-shifting circuit further including a control input receiving a control signal and an output which delivers an output signal corresponding to the signal received at the input phase-shifted according to said control signal, and each variable phase-shifting circuit further including a synchronized oscillator having at least one synchronization input coupled to said variable phase-shifting circuit input for receiving said input signal, at least one output coupled to said output of the variable phase-shifting circuit for delivering said output signal, wherein said synchronized oscillator has a variable free-running oscillation frequency which is controlled by said control signal;

a signal output which delivers an output signal;

a multiplexer having N1 inputs which receive the N1 signals delivered by the respective output of the N1 variable phase-shifting circuits and an output that delivers one of said N1 signals according to the value of a given number Q of the most significant bits of the digital input value, where Q is an integer less than or equal to P.

Thanks to the structure of the variable phase-shifting circuits, it is possible to obtain a very fine interpolation step from a small number N1 of variable phase-shifting circuits. This results in accurate interpolation.

Advantageously, the interpolator may further include a digital/analog converter having N1 inputs that receive the P-Q least significant bits of the digital input value, and having an output which, based on the value of said P-Q bits, delivers an analog phase-shift correction signal which is applied to the control input of at least one of the N1 first variable phase-shifting circuits.

This correction signal can be used to change the phase shift introduced by the phase-shifting circuit whose output is selected by the multiplexer for delivering the interpolator output signal. Thus, one can accurately interpolate phase values between the N1 phase values respectively generated by the aforementioned N1 variable phase-shifting circuits. Phase interpolation performances are further improved, without increasing the number of phase-shifting circuits used.

### BRIEF DESCRIPTION OF THE DRAWINGS

FIG. 1 is a symbolic diagram of a synchronized oscillator according to prior art;

FIG. 2 is a graph illustrating the change in frequency of the output signal with respect to the input signal frequency of a synchronized oscillator;

FIG. 3 is a graph showing the output signal phase shift with respect to the input signal of a synchronized oscillator, as a function of the difference between the synchronization frequency and the free-running oscillation frequency of the oscillator;

FIG. 4 is a symbolic diagram of a variable phase-shifting circuit according to the invention;

FIG. 5 is a detailed diagram of an exemplary embodiment of a variable phase-shifting circuit according to the invention;

FIG. 6 is a graph showing the output signal phase shift with respect to the input signal of the variable phase-shifting circuit in FIG. 5;

FIG. 7 is a timing diagram of a signal affected by jitter (signal to be interpolated);

FIG. 8 is a diagram of an exemplary embodiment of a phase interpolator according to the invention;

FIG. 9 is a graph illustrating the characteristic of a digital/analog converter;

FIG. 10 is a diagram illustrating the phase positioning of eight variable phase-shifting circuits used in a phase interpolator according to FIG. 8;

FIG. 11 is a timing diagram of the phase interpolator output signal in FIG. 8;

FIG. 12 is a detailed diagram of an exemplary transconductance circuit used in a phase interpolator according to FIG. 8;

FIG. 13 is a schematic representation of a first example of a digital frequency synthesizer according to the invention;

FIG. 14 is a schematic representation of a second example of a digital frequency synthesizer according to the invention; and

FIG. 15 is a schematic representation of a third example of a digital frequency synthesizer according to the invention;

An oscillator is a circuit which includes self-oscillating means and an output for generating an oscillating signal. An oscillator is characterized by a free-running frequency, hereafter designated as Fo, which is normally the output signal frequency.

All oscillators, however, have the property of copying the frequency of an interfering signal if this is close to the free-running oscillation frequency Fo of the oscillator. All oscillators are thus characterized by a synchronization range whose width depends on the amplitude of the interfering signal and the topology of the oscillator. Knowing the amplitude of the interfering signal (called the synchronization signal), it is possible to calculate the synchronization range ΔF of the oscillator based on calculating the oscillator's elasticity factors. The study of synchronized oscillators is described in “Contribution to the study of oscillator synchronization: integration of synchronous oscillators into silicon technology radio frequency systems”, Chapter 3, F. Badets, Thesis submitted at the University of Bordeaux 1 on Jan. 25, 2000, Order No. 2199.

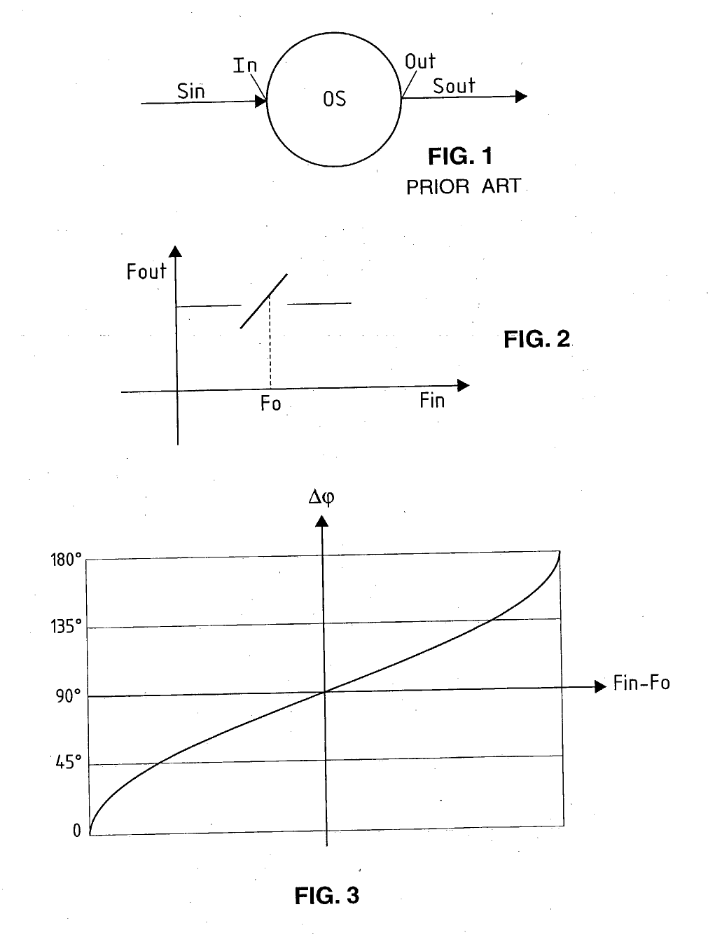

A synchronized oscillator OS is'shown diagrammatically in FIG. 1. This includes an input In for receiving a synchronization signal Sin, and an output Out for delivering an output signal Sout. The free-running frequency of the oscillator is denoted by Fo, the synchronization signal frequency by Fin and the output signal frequency by Fout.

The change in the frequency Fout as a function of the frequency Fin is illustrated -by the graph in FIG. 2. As can be seen on this graph, the frequency Fout is equal to the frequency Fo for values of Fin outside the synchronization range ΔF, this being centered on the value Fo. For values of Fin inside the synchronization range ΔF, the value of Fout is equal to Fin. In other words, the gradient of the curve of the function giving Fout as a function of Fin is equal to one in the synchronization range ΔF, and to zero outside of this range.

When the oscillator is synchronized, the difference in phase ΔΦ between the synchronization signal Sin and the oscillator output signal Sout is only a function of Fin, Fo and ΔF. This relationship forms an Arcsin distribution, as the graph in FIG. 3 shows. When Fin is equal to Fo, the phase shift ΔΦ is equal to 90° (modulo 180°). The variation in phase shift ΔΦ is substantially linear between 45° and 135° (modulo 180°).

In conventional applications of synchronized oscillators, the input value is the synchronization signal frequency Sin. According to the invention, this value is left fixed and the free-running oscillation frequency Fo of the oscillator is altered like a controlled oscillator. Of course, in order for the oscillator to remain synchronized, the variation in frequency Fo is limited so that the frequency Fin remains within the resultant synchronization range ΔF of the oscillator. Thus the frequency Fout is equal to Fin. In what follows, the term “synchronized oscillator” refers to an oscillator that meets this condition. Thus, the phase shift ΔΦ of the oscillator output signal is controlled with respect to the synchronization signal. In other words, a variable phase-shifting circuit is obtained comprising a synchronized oscillator and a control input receiving a control signal whose function is to vary the phase shift ΔΦ between the output signal and the input signal of the synchronized oscillator by varying the free-running oscillation frequency Fo of this oscillator.

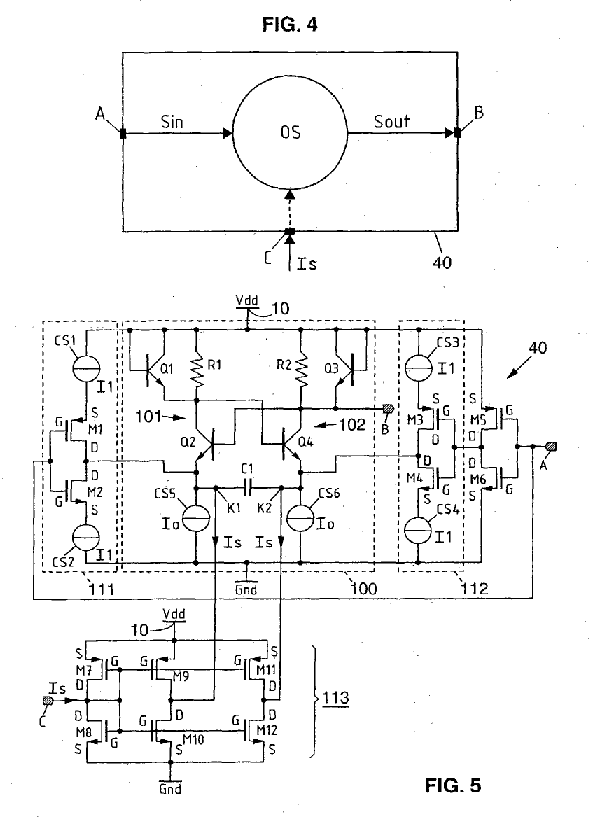

FIG. 4 shows a schematic representation of a variable phase-shifting circuit 40 according to the invention. The circuit 40 includes an input A for receiving an input signal, an output B for delivering an output signal, and a control input C for receiving a phase-shift control signal Is. The signal Is controls the phase shift ΔΦ of said output signal with respect to said input signal. Preferably, this is an analog value. More specifically, it is a control current, although a control voltage is also conceivable.

FIG. 5 shows a proposed embodiment for the variable phase-shifting circuit 40 according to the invention.

The circuit 40 includes an oscillator that generates an oscillating signal having a specified free-running oscillation frequency Fo, together with synchronization means for receiving a synchronization signal having a specified frequency within the synchronization range ΔF of the oscillator, which is determined in particular by the free-running oscillation frequency Fo.

In one example, the oscillator includes an astable multivibrator circuit 100 comprising two branches 101 and 102 arranged in parallel, each between a positive supply terminal 10 receiving a positive supply voltage Vdd, and a negative supply terminal or the ground Gnd.

The first branch 101 of the circuit 100 includes, in series between the terminal 10 and the ground Gnd, a bipolar transistor Q1 configured as a diode (i.e. with its base connected to its collector), a bipolar transistor Q2, and a current source CS5. The collector and the base of the transistor Q1 are connected together and to the terminal 10. The emitter of the transistor Q1 is connected to the collector of the transistor Q2. The emitter of the transistor Q2 is further connected to the ground Gnd via the current source CS5.

The second branch 102 of the circuit 100 includes, in series between the terminal 10 and the ground Gnd, a bipolar transistor Q3 configured as a diode, a bipolar transistor Q4, and a current source CS6. The collector and the base of the transistor Q3 are connected together and to the terminal 10. The emitter of the transistor Q3 is connected to the collector of the transistor Q4. The emitter of the transistor Q4 is further connected to the ground Gnd via the current source CS6. The output B of the variable phase-shifting circuit 40 is sampled at the collector of the transistor Q4 of the branch 102 of the multivibrator circuit 100.

The branch 101 further includes a resistance R1 connected between the terminal 10 and the collector of the transistor Q2. Similarly, the branch 102 further includes a resistance R2 connected between the terminal 10 and the collector of the transistor Q4.

In addition, the base of the transistor Q2 is connected to the collector of the transistor Q4 (output B), and the base of the transistor Q4 is connected to the collector of the transistor Q2.

Finally, the circuit 100 includes a capacitor C1 connected between the respective emitters of the transistors Q2 and Q4. In one example, the capacitance value of the capacitor C1 is equal to 0.8 pF (pico-Farad).

The current sources CS5 and CS6 deliver a respective constant current of the same specified value denoted by Io. In one example, Io is equal to 250 μA (micro-amperes).

In addition, the synchronization means include a branch 111 and a branch 112 arranged in parallel with the branches 101 and 102 of the circuit 100 between the terminal 10 and the ground Gnd. The branch 111 includes, in series between the terminal 10 and the ground, a current source CS1, a transistor M1 which is a P-type MOS transistor (PMOS transistor), a transistor M2 which is an N-type MOS transistor (NMOS transistor), and a current source CS2. The control grids G of the transistors M1 and M2 are connected together. In addition, the common drains D of the transistors M1 and M2 are connected to the emitter of the transistor Q2 of the branch 101 of the circuit 100.

The branch 112 includes, in series between the terminal 10 and the ground, a current source CS3, a transistor M3 which is a PMOS transistor, a transistor M4 which is an NMOS transistor, and a current source CS4. The control grids G of the transistors M3 and M4 are connected together. In addition, the common drains D of the transistors M3 and M4 are connected to the emitter of the transistor Q4 of the branch 102.

The current sources CS1, CS2, CS3 and CS4 deliver a respective current having the same value I1. In one example, I1 is equal to 100 μA.

The input A of the variable phase-shifting circuit is connected to the common grids G of the transistors M1 and M2 of the branch 111. It is also connected to the common grids G of the transistors M3 and M4 of the branch 112 via an inverter M5-M6.

The inverter M5-M6 includes a transistor M5 which is a PMOS transistor and a transistor M6 which is an NMOS transistor, connected in series between the terminal 10 and the ground Gnd. The control grids G of the transistors M5 and M6 are connected together and to the input A. The common drains D of the transistors M5 and M6 are connected to the common grids G of the transistors M3 and M4 of the branch 112.

In operation, the input A receives an input signal, the synchronization signal Sin described earlier, which has a specified oscillaton frequency Fin.

In a preferred embodiment, the control signal Is received at the control input C is a control current. Several control signals of this nature can then be applied to the input C by direct connection, enabling the respective effects of each of these signals on the phase shift ΔΦ to be added together.

The variable phase-shifting circuit further includes means for passing a respective quiescent current, of the same value Io+Is, along the branches 101 and 102 of the circuit 100. In other words, this quiescent current includes a fixed part Io which is delivered by the current source CS5 and CS6 respectively, and a variable part which is the phase-shift control current Is. In the general case, it is said that the current Is is added to the current Io. This is an algebraic sum, the current Is being able to be positive or negative.

In each branch 101 or 102, the current is sampled or fed onto a node K1 or K2 respectively, which is the node common to the emitter of the bipolar transistor, Q2 or Q4 respectively, and which is the positive terminal of the current source, CS5 or CS6 respectively.

For this purpose, in accordance with the embodiment in FIG. 5, the variable phase-shifting circuit includes a current mirror 113. The current mirror 113 comprises three branches connected in parallel between the terminal 10 and the ground Gnd. The first branch includes a first transistor M7 and a second transistor M8, which are MOS transistors configured as diodes, connected in series between the terminal 10 and the ground Gnd via their respective drains D. The second and third branches each include a first MOS transistor, M9 and M1 respectively, and a second MOS transistor, M10 and M12 respectively, in series between the terminal 10 and the ground Gnd. The transistors M7, M9 and M11 are PMOS transistors whose source S is connected to the terminal 10. Their respective control grids G are connected together. The transistors M8, M10 and M12 are NMOS transistors whose source is connected to the ground Gnd. Their respective grids G are connected together and to the control grids G of the transistors M7, M9 and M11.

The common grids G of the six transistors M7-M12 are connected to the input C of the variable phase-shifting circuit 40, which receives the control signal Is (which is a control current Is in the example). The drains D of the transistors M9 and M10 of the second branch are both connected to the node K1 of the first branch 101 of the circuit 100. Similarly, the drains D of the transistors M11 and M12 of the third branch are both connected to the node K2 of the second branch 102 of the circuit 100.

Thus, the control current Is received at the input C is duplicated by the current mirror 113 in order to generate two currents Is of the same value, which are sampled or fed onto the nodes K1 and K2 respectively.

In a variant, the variable phase-shifting circuit 40 includes two control inputs like the input C, each for receiving an identical control signal Is. In this case, both of these inputs are connected to the nodes K1 and K2 respectively, and the current mirror 113 can be omitted. This amounts to saying that the current mirror 113 can be included in the element which generates the control signal Is instead of being included in the variable phase-shifting circuit 40. It can also be included in an element situated between the said element and the circuit 40.

The free-running oscillation frequency Fo of the astable multivibrator 100 is given by the following relationship:

(2)

where C1 designates the capacitance value of the capacitor C1.

and where Vbe designates the base-emitter voltage of the transistors Q1 and Q3.

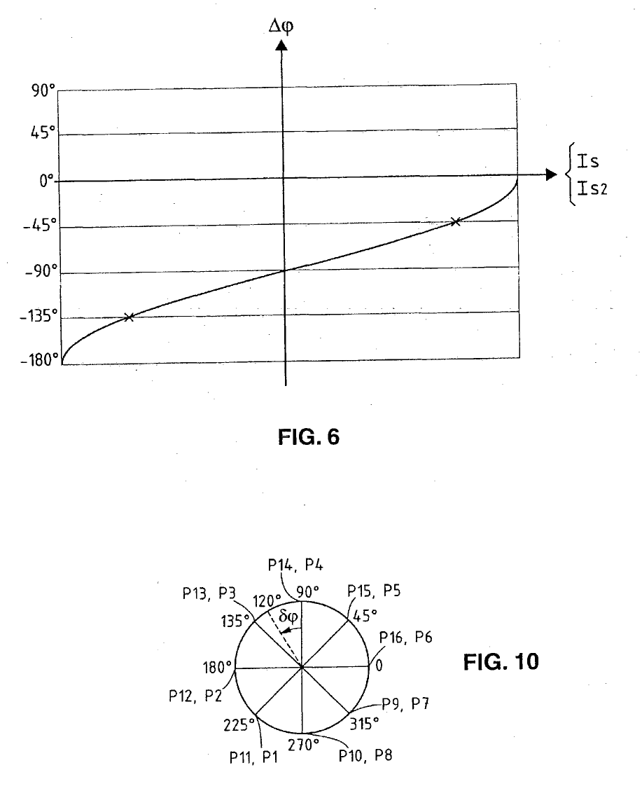

FIG. 6 shows the graph of the phase-shift ΔΦ of the signal delivered by the output B with respect to the signal received at the input A as a function of the phase-shift control signal Is received at the input C, of the variable phase-shifting circuit 40 in FIG. 5.

This graph has the general appearance (Arcsin function) already illustrated in the graph in FIG. 3. However, taking into account the structure of the circuit in FIG. 5, the phase-shift ΔΦ is equal to −90° for the zero value of the phase-shift control current Is. The phase shift varies linearly when the control current Is varies between two specified values which give a phase shift ΔΦ equal to −135° and −45° respectively.

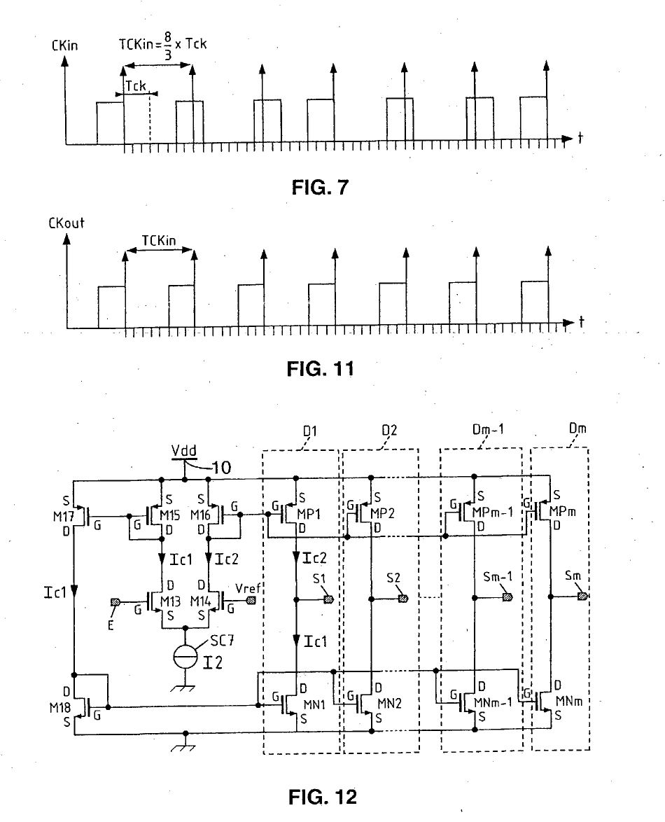

FIG. 7 is a timing diagram of a signal CKin affected by a jitter, which in the example is a periodic signal (although the invention is not limited to the case of a signal to be interpolated being periodic). A periodic signal affected by jitter is understood to mean a digital signal including a recurrent pulse whose position fluctuates over time, having an average period TCKin corresponding to r times a theoretical period Tck, where r is a real number. In other words, the signal has recurrent pulses which are only periodic when averaged over several pulses. In the example shown, r is equal to

If the actual instants of switching of the signal pulses are considered (corresponding, for example, to the falling edges of the pulses) with respect to the theoretical instants of switching, determined by a reference signal with the frequency 1/Tck, the instant of switching of at least some of the signal pulses CKin shown is behind or in advance of an associated theoretical instant of switching.

In the example shown, the first pulse (the farthest left) has a switching instant corresponding to a theoretical switching instant. In other words, the pulse is in phase with the reference signal with the frequency 1/Tck. The second pulse is a third of the period Tck later than a theoretical switching instant, i.e. the signal CKin is individually phase-shifted by 360°/3=120° with respect to the reference signal with the frequency of 1/Tck. The third pulse is two-thirds of the period Tck later than a theoretical switching instant, i.e. the signal CKin is individually phase-shifted by 360°×⅔=240° with respect to the reference signal with the frequency 1/Tck. The fourth pulse is again in phase with the reference signal etc. It should be noted that this is a particularly simple example. In the general case, the delay (or advance) of the actual instant of switching of a pulse with respect to a theoretical instant of switching is not necessarily equal to a whole fraction of the theoretical period Tck.

A signal such as the signal CKin shown in FIG. 7 is for instance generated by a phase accumulator including a 3-bit adder, activated by a specified clock signal with an added increment equal to 3. The reference signal with the frequency 1/Tck then corresponds to this clock signal. In general, the invention applies to phase interpolation of a signal affected by a jitter which can be produced by any synchronous digital circuit (phase accumulator or other type), whose timing can be regulated by a clock signal of a specified frequency.

When the signal affected by a jitter is a signal intended to be transmitted in the radio frequency spectrum, the periodicity of the jitter is expressed as spurious frequencies in the spectrum of the transmitted signal. Jitter is conventionally eliminated thanks to a phase interpolation circuit, or phase interpolator. This is why from now on this signal is also called the signal to be interpolated.

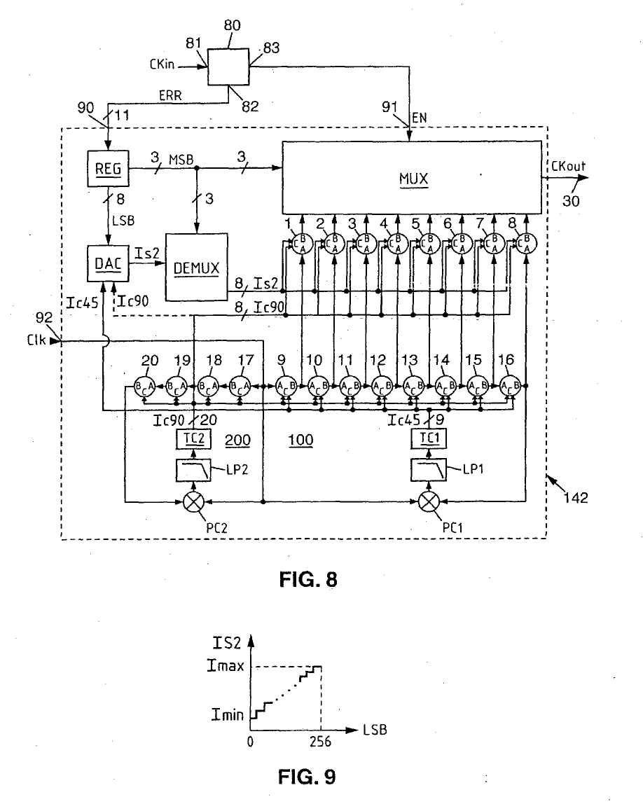

FIG. 8 schematically shows an exemplary embodiment of a phase interpolator 142 according to the invention. For the sake of clarity, the connections comprising a given number n of wires, where n is an integer greater than one, are shown in the figure by a single line. As necessary, “/n” is then shown across this single line.

The phase interpolator 142 includes an output 30 for delivering an output signal CKout, also called an interpolated signal in the following text.

It is assumed that a control module 80 includes an input 81 for receiving an input signal CKin, which is a signal, whether periodic or not, affected by a jitter. The module 80 also includes an output 82 that delivers successive digital values ERR, to which we shall return below. It further includes an output 83 that delivers an activation signal EN (which is a binary signal) to which we shall also return later.

The module 80 may be split into several entities, according to the application. As a variant, it may-be included in the phase interpolator 142 itself.

The interpolator 142 includes a signal input 92 for receiving a reference signal with a specified frequency, which is for instance a clock signal Clk. The signal Clk is for instance the clock signal which provides the timing of the digital circuit generating the signal CKin.

In addition, the interpolator 142 includes at least one data input 90 for receiving a digital input value ERR coded over a given number P of bits, where P is an integer greater than one. In one example, P is equal to eleven (P=11). The digital input values ERR represent the time difference between an actual instant of switching of a pulse of the signal to be interpolated CKin and a desired instant of switching of the output signal CKout, which is, for example, determined by an average period of the signal to be interpolated (especially when the signal CKin is generated by a phase accumulator). In other words, they represent individual phase-shifting of the signal CKin with respect to its average frequency 1/TCKin. In this example, the digital input values are successively received at a frequency substantially equal to 1/TCKin. They are stored in a register REG.

The Q most significant bits of the digital input value are denoted by MSB, where Q is an integer strictly less than P. In an example, Q is equal to three (Q=3). Similarly, the P-Q least significant bits of said digital input value are denoted by LSB. In the example, P-Q is equal to eight (P-Q=8). The MSB encode a rough value of the aforementioned time difference, and the LSB encode an additional value specifying the value of this difference.

As a variant, the interpolator 142 includes two inputs in place of the input 90, one receiving the P MSB and the other receiving the P-Q LSB. The register REG can then be omitted.

The interpolator 142 further includes a given number N1 of first variable phase-shifting circuits, where N1 is an integer strictly greater than one. In an example, N1 is equal to eight (N1=8). These eight variable phase-shifting circuits 1 to 8 are identical. For example, they conform to the exemplary embodiment described earlier in relation to FIG. 5. Each of them includes a synchronized oscillator, an input A which receives an input signal having the frequency 1/Tck of the reference signal Clk as the oscillator synchronization signal, a control input C which receives a control signal, and an output B which delivers the oscillator output signal. The latter corresponds to the signal received at the input A phase-shifted according to a control signal which is received at the control input C. The input signals received by the respective inputs A of these N1 variable phase-shifting circuits have the frequency 1/Tck of the reference signal Clk. In addition, they are phase-shifted two at a time by 360°/N1, i.e. by 45° in the example where N1=8.

The interpolator 142 further includes a multiplexer or MUX having N1 inputs connected to the respective outputs B of the N1 variable phase-shifting circuits 1 to 8, an output which is connected to an output 30 of the interpolator for delivering an output signal CKout, and at least Q control inputs that receive the Q MSB of the digital input value. The multiplexer is activated by the signal EN delivered by the output 83 of the control module 80 and received at the, input 91 of the interpolator 142. When it is activated by the signal EN (for example when EN is in a high logical state), this MUX has the function of selecting one of the N1 signals delivered by the respective outputs B of the N1 circuits 1 to 8, based on the value of said Q MSB. The signal thus selected is delivered to the output 30 of the interpolator. The signal EN is used to activate/deactivate the MUX in order to modify the frequency of the output signal CKout with respect to the frequency of the reference signal Clk.

Preferably, the interpolator 142 further includes a digital-to-analog converter or DAC (here an 8-bit DAC) having P-Q inputs which respectively receive the P-Q LSB, and having an output which delivers an analog phase-shift correction signal Is2 based on the value of the said P-Q bits. This phase-shift correction signal Is2 is used to improve phase interpolation, since it enables the value of the phase actually required to be given to the signal at the output of the variable phase-shifting circuit whose output is selected by the multiplexer. In other words, the output of one of the circuits 1 to 8 is selected based on the rough value of the phase shift of the signal CKin (given by the MSB) and the phase shift introduced by this circuit is adjusted by the correction signal Is2 as a function of the difference (given by the LSB of the digital input value) between this rough value and the actual value of the phase shift of the signal CKin (given by the P bits of the digital input value).

The phase-shift correction signal Is2 can be delivered to the control input C of each of the N1 variable phase-shifting circuits 1 to 8. In fact, the output of only one of these circuits is selected by the MUX to generate the output signal CKout. However, in order to increase the speed of acquisition of the phase in the event of modifying the control signal, it is preferable to leave the other variable phase-shifting circuits with the phase-shift value corresponding to a zero phase-shift correction signal.

This is why the interpolator 142 preferably includes a demultiplexer DEMUX having an input receiving the phase-shift correction signal Is2, at least N1 outputs respectively coupled to the respective control input C of the N1 variable phase-shifting circuits 1 to 8, and at least Q control inputs receiving the Q MSBof the digital input value. This demultiplexer has the function of selecting those of the N1 outputs coupled to the input based on the value of the Q MSBof the digital input value. In other words, it directs the phase-shift correction signal Is2 towards the control input C of only one of the variable phase-shifting circuits 1 to 8 based on the value of said Q MSB.

For generating the N1 signals transmitted at the input of the variable phase-shifting circuits 1 to 8, the phase interpolator may further include a multiphase clock generator 100. Such a generator preferably includes N1 second variable phase-shifting circuits 9 to 16 which are identical to the N1 first variable phase-shifting circuits 1 to 8. The circuits 9 to 16 are connected in series via their respective inputs A and outputs B. The input of a first one 9 of these N1 second variable phase-shifting circuits receives the input signal CKin.

Other phase-shifting elements could be used instead and in place of the N1 second variable phase-shifting circuits, for instance inverters or elements introducing any delay. However, the example envisaged here is advantageous since it provides a reference value for calibrating the DAC.

The generator 100 also includes a phase comparator PC1 having a first input which receives the reference signal Clk, a second input which is connected to the output of a last 16 of the N1 second variable phase-shifting circuits 9 to 16, and an output.

The generator 100 also includes a low-pass filter LP1 having an input coupled to the output of the phase comparator PC1, and an output.

Finally, it includes an adaptation module TC1 having an input coupled to the output of the low-pass filter LP1 and at least an output delivering a calibration signal Ic45 to be applied to the respective control inputs C of the circuits 9 to 16. When the control inputs C of circuits 9 to 16 are adapted to receive a control current, as is the case in the preferred exemplary of embodiment, the module TC1 is a transconductance circuit. The module TC1 thus includes at least N1 first outputs delivering respectively N1 identical analog calibration signals Ic45. These outputs are coupled to the respective control inputs C of the N1 second variable phase-shifting circuits 9 to 16, for delivering one of the signals Ic45.

Stated otherwise, the generator 100 is a delay-locked loop (DLL), whose delaying elements are variable phase-shifting circuits according to the first aspect of the invention.

The DAC must be calibrated so as to control the Imin and Imax values of the phase-shift correction current Is2 which it delivers, for the value 0 and for the value 256 respectively, determined by the eight LSB of the digital input signal. These Imin and Imax values determine the limits of the response of the DAC. This response is shown in the graph in FIG. 9 in the case of a converter having a linear characteristic. It should be noted that a digital/analog converter having a linear characteristic is a preferred, but in no way restrictive case. A nonlinear characteristic may be more appropriate in certain applications of the interpolator, in view of the properties of the jitter to be corrected and/or the response gradient of the variable phase-shifting circuits used.

The calibration of the DAC requires the knowledge of two reference values, i.e. two values of the control current to be applied at the control input C of a variable phase-shifting circuit such as circuits 1 to 8 used, respectively for two different specified values of the phase shift ΔΦ. Preferably, these two values of the phase shift ΔΦ correspond directly to the aforementioned Imin and Imax values of the current Is. However, this is in no way mandatory. In fact, the values Imin and Imax may be extrapolated from at least any two reference values. Also preferably, the reference values belong to a linear portion of the response curve of the variable phase-shifting circuits used. The design of the interpolator is then simpler.

Advantageously, the multiphase clock signal generator 100, as embodied in the preferred example described above, already provides such a reference value. It is known that the calibration signal Ic45 generated by the output of the adaptation module TC1 of the generator 100 produces a phase shift ΔΦ in the signal at output B with respect to the signal at the input A of circuits 9 to 16 which is equal to −45°. We therefore already have one of the two reference values required that can easily be used.

Accordingly, the adaptation module TC1 of the multiphase clock generator 100 includes an N1+1-th output, delivering an N1+1-th calibration signal Ic45 identical to the N1 other calibration signals Ic45 generated. This N1+1-th output is coupled to the DAC to supply it with a first reference value for its calibration.

Stated otherwise, the generator 100 then also provides the function of first calibration means generating a first calibration signal Ic45 for calibrating the converter DAC.

It shall be noted that, when the multiphase clock signal generator 100 is produced differently (for instance thanks to a phase-locked loop, or by a DLL having inverters as delaying circuits), calibration means of the same nature as the generator 100 may be specifically provided for obtaining the calibration signal Ic45 needed for calibrating the DAC.

To obtain a second reference value for calibrating the DAC, the phase interpolator according to the invention may further include second calibration means 200 comprising a given number N2 of third variable phase-shifting circuits, where N2 is an integer. For example, N2 is equal to four (N2=4). These four variable phase-shifting circuits 17 to 20 are identical to the N1 first variable phase-shifting circuits 1 to 8. They are therefore also identical to the N1 second variable phase-shifting circuits 9 to 16 of the generator 100. Furthermore, they are connected in series via their respective inputs A and outputs B, the input of a first 17 of these N2 third variable phase-shifting circuits receiving the reference signal Clk.

The second calibration means 200 also include a phase comparator PC2 having a first input which receives the reference signal Clk, a second input connected to the output of a last one 20 of the N2 third variable phase-shifting circuits, and an output.

They also include a low-pass filter LP2 having an input coupled to the output of the phase comparator PC2, and an output.

Finally, they include an adaptation module TC2, of the same nature as the module TC1 of the generator 100, having an input coupled to the output of the low-pass filter LP2 and at least one output delivering an analog calibration signal Ic90 to be applied to the phase-shift control inputs C of circuits 17 to 20, and in addition to be delivered to the DAC for its calibration. Since these inputs C are suitable for receiving a current as control signal, the module TC2 may include N2+1 outputs each delivering an identical analog calibration signal Ic90. N2 of these inputs are coupled to the respective control inputs C of the N2 second variable phase-shifting circuits 17 to 20, for delivering a respective one among N2 of the N2+1 signals Ic90. The last output is coupled to the DAC for delivering the N2+1-th of the N2+1 signals Ic90 in order to provide it with a second reference value for calibrating it (this coupling being shown as a dasked line in FIG. 8, since it does not correspond to the preferred embodiment).

Stated otherwise, the calibration means 200 comprise a DLL, whose delaying elements are variable phase-shifting circuits according to the first aspect of the invention. The calibration signal Ic90 produces a phase shift of −90° when it is applied to the control input C of such a variable phase-shifting circuit.

In a preferred embodiment of the phase interpolator, the signal Ic90 is not coupled to the DAC. It is considered that a second reference value corresponds to a zero value of the phase shift correction current Is2 and to a value of the phase shift ΔΦ equal to −90°. Accordingly, the simplest possible digital-to-analog converter can be used, for which the zero value of the LSB provides a zero value for the phase shift correction signal Is2, i.e. the converter response (FIG. 9) passes through the origin (Imin=0).

In this preferred embodiment (which corresponds to the one shown in solid lines in FIG. 8), the adaptation module TC2 then includes N2+2×N1 outputs respectively delivering N2+2×N1 identical calibration signals Ic90, including:

N2 signals Ic90 are applied to the respective control inputs C of the N2 second variable phase-shifting circuits 17 to 20;

N1 other signals Ic90 are applied to the respective control inputs C of the N1 second variable phase-shifting circuits 9 to 16 of the multiphase clock generator 100; and

N1 other signals Ic90 are applied to the respective control inputs C of the N1 first variable phase-shifting circuits 1 to 8.

In the example considered in the present description, the number N2+2×N1 is equal to twenty (N2+2×N1=20). The fact of applying the calibration signal Ic90 to the control input C of each of the variable phase-shifting circuits 1 to 20 (in the absence, moreover, of any phase correction signal Is2 for circuits 1 to 8) ensures that each of these circuits has a phase shift ΔΦ which is strictly equal to −90°, despite dispersions on the values of the current Io, the capacitor C1 and the voltages Vbe resulting from the method of production on silicon and/or temperature-linked phenomena. This is why, in this case, the calibration signal Ic90 does not need to be supplied to the DAC. It is, in fact, ensured that, for a zero value of the phase correction signal Is2, the phase shift ΔΦ of circuits 1 to 8 will definitely be equal to −90°.

It shall be noted that the signal Ic90 is added to the signal Ic45 at the control input C of circuits 9 to 16 (for these circuits, Is=Ic90+Ic45), so that their respective effects on the phase shift ΔΦ of these circuits are added together. Similarly, the signal Ic90 is added to the phase shift correction signal Is2 at the control input C of circuits 1 to 8 (for these circuits, Is=Ic90+Is2), so that their respective effects on the phase shift ΔΦ of these circuits are added together.

The response of the variable phase-shifting circuits 1 to 8 as a function of the phase shift correction signal Is2 is shown in the graph in FIG. 6, already discussed. The circuits 1 to 8 are used in the portion of their characteristic between phase shift ΔΦ values equal to −90° and −45°, for a value of LSB equal to 0 and 256 respectively.

The diagram in FIG. 10 illustrates the phase shift, with respect to the reference signal Clk, of the output signals of circuits 1 to 8 in the absence of any phase shift correction signal Is2 (i.e. for LSB=0 so that the signal Is2 is zero), as well as the signals at the output of circuits 9 to 16. In this figure, the phases of circuits 1 to 16 are denoted by P1 to P16, respectively, with respect to the signal phase Clk taken as reference. By construction, each of the circuits 1 to 16 introduces a phase shift of −90° between its input A and its output B. In addition, by virtue of its position in the DLL of the generator 100, each of the circuits 9 to 16 introduces a phase shift of +45° between its input A and its output B. Thus, in practice, each of the circuits 9 to 16 introduces a phase shift of −90°+45°=−45° between its input A and its output B. This means that the phase P9 is equal to −45° (that is, 315° modulo 360°), phase P10 is equal to −90° (that is, 270° modulo 360°), etc. It also means that the phase P1 is equal to −90°+45°−90°=−235° (that is, 225° modulo 360° ), phase P2 is equal to −180° (that is, 180° modulo 360° ), etc.

As an example of the operation of the interpolator 142, let us assume that the difference between the actual instant of switching of a pulse of the signal to be interpolated CKin and the desired instant of switching of the output signal CKout, as indicated by the digital input value received at the input 80, and as determined with respect to the period Tck of the reference signal Clk, corresponds to an individual phase shift of 120° of the CKin signal with respect to the frequency 1/Tck of the reference signal Clk. The MSB then have a value that causes the MUX to select the signal delivered by the output B of the variable phase-shifting circuit 4 whose input signal has a phase shift of 90° (that is, −270° modulo 360) with respect to the reference signal Clk which is the closest (in lower value) to the said individual phase shift. In addition, the MSB cause the DEMUX to direct the phase-shift correction signal Is2 towards the control input C of the circuit 4. Finally, the LSB have a value that causes the phase-shift correction signal Is2 generated by the DAC to add an additional phase shift δΦ of 30° (shown by an arrow in FIG. 10) which is the phase shift ΔΦ of the output signal of circuit 4 with respect to the input signal of this circuit. In fact, the correction signal Is2 subtracts a phase shift of −30° since it causes circuit 4 to introduce a phase shift of −60° instead of a phase shift of −30°.

The output signal 142 of the interpolator is shown in the timing diagram in FIG. 11. As can be seen, the jitter has been eliminated. The pulses have an instant of switching in phase with the desired instant of switching, which here is determined by the period Tck (vertical arrows).

FIG. 12 shows an example of embodiment of the adaptation modules TC1 and TC2.

The adaptation module is a transconductance circuit including an input E and a given number m of outputs S1 to Sm, where m is an integer. For example, in the module TC1 of the generator 100, the number m is equal to 9. Similarly, in the case of the module TC2 of the calibration means 200, the number m is equal to 20.

The module includes a differential pair with a MOS transistor M13 and a MOS transistor M14, which are NMOS transistors. The control grid G of the transistor M13 is connected to the input E. The control grid G of the transistor M14 receives a reference voltage Vref. The sources S of the transistors M13 and M14 are connected together and to the ground via a current source SC7. The current source SC7 delivers a current I2. The drain D of the transistor M13 is connected to the positive supply terminal 10 via a transistor M15 configured as a diode. Similarly, the drain D of the transistor M14 is connected to the terminal 10 via a MOS transistor configured as a diode M16. The transistors M15 and M16 are PMOS transistors, whose sources S are connected to the terminal 10, whose drains D are connected to the respective drains D of the transistors M13 and M14, and whose control grids G are connected to their respective drain D. The transistor M15 is configured as a current mirror with a transistor M17 and a transistor M18. The transistors M17 and M18 are connected in series between the terminal 10 and the ground Gnd. The transistor M17 is a PMOS transistor whose source S is connected to the terminal 10 and whose grid G is connected to the grid G of the transistor M15. The transistor M18 is an NMOS transistor whose source S is connected to the ground Gnd, whose drain D is connected to the drain D of the transistor M17, and whose control grid G is connected to its drain D.

The adaptation circuit further includes m output stages D1 to Dm respectively. Each stage D1 to Dm includes a first transistor, MP1 to MPm respectively, and a second transistor MN1 to MNm respectively, connected in series between the terminal 10 and the ground Gnd. The transistors MP1 to MPm are PMOS transistors whose source S is connected to the terminal 10, whose drain D is connected to the output S1 to Sm respectively of the adaptation circuit. The transistors MN1 to MNm are NMOS transistors whose source S is connected to the ground Gnd, whose drain D is connected to the output S1 to Sm respectively of the adaptation circuit. In addition, the common control grids G of the transistors MP1 to MPm are connected to the control grid of the transistor M16. In addition, the common control grids G of the transistors MN1 to MNm are connected to the control grid G of the transistor M18.

The operation of this adaptation module is as follows. The input E receives the signal delivered by the output of the low-pass filter LP1 (for the module TC1) or of the low-pass filter LP2 (for the module TC2). Based on the difference between the voltage corresponding to this signal and the voltage Vref, applied on the respective grids of the transistors M13 and M14 of the differential pair, currents Ic1 and Ic2 are established in the two branches of the said differential pair, respecting the equality Ic1+Ic2=I2. Since the transistors M15, M17, M18 and MN1 to MNm are configured as a current mirror, the current Ic1 is found on the drains D of the transistors MN1 to MNm. Similarly, since the transistors M16 and MP1 to MPm are configured as a current mirror, the current Ic2 is found on the drains D of the transistors MP1 to MPm. Accordingly, the outputs S1 to Sm deliver a current corresponding to the difference between the currents Ic1 and Ic2. This current is a control current that corresponds to the calibration current Ic45 for the module Tc1 and to the calibration current Ic90 for the module Tc2.

The phase interpolator finds applications in the field of digital frequency synthesis.

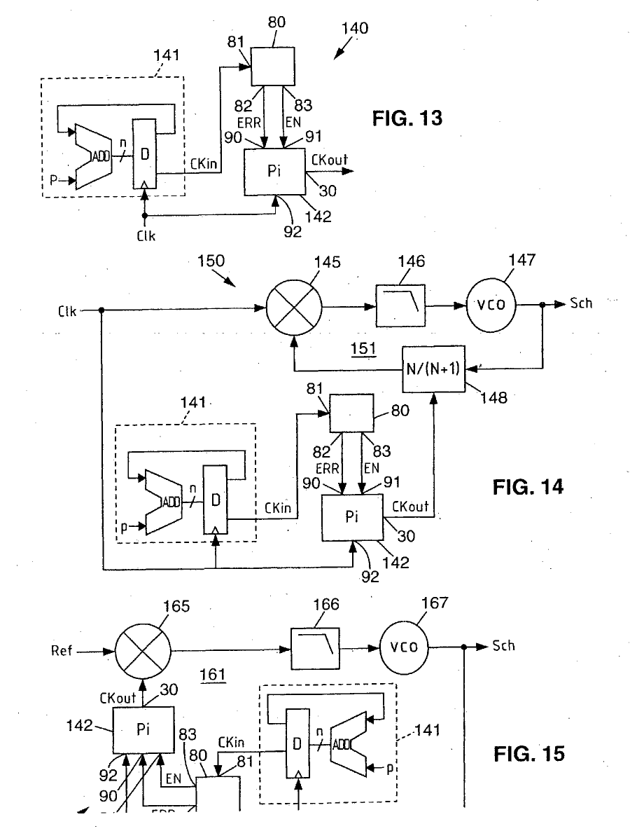

The diagram in FIG. 13 illustrates a first embodiment of a digital frequency synthesizer 140 comprising a phase interpolator 142 according to the second aspect of the invention and an associated control circuit 80, like those described above in reference to the exemplary of embodiment shown in FIG. 8.

This first exemplary embodiment of a synthesizer is a “1-bit” direct frequency synthesizer. It includes a phase accumulator 141. This phase accumulator 141 includes an adder ADD which is an n-bit adder, where n is an integer, receiving at a first input an additional increment p, where p is an integer. The output value of the adder ADD is stored in a register R consisting of D latches, from which an output is looped onto a second input of the adder ADD. The register R is activated by a clock signal Clk.

The operation of the accumulator is as follows. At each rising edge of the clock signal Clk, the adder ADD is incremented by a value p. When the result of the addition is greater than the capacity of the adder, which is equal to 2ⁿ, a bit called an “overflow bit” is generated at a second output of the register R. The result of this addition (modulo 2ⁿ) then acts as the starting value for the next addition cycle. The output signal of the phase accumulator 141 is generated by the said second output of the register R, and is composed of a succession of pulses corresponding to the occurrences of the overflow bit. In the event that p and n are equal to 3, this output signal is the signal CKin shown in the timing diagram in FIG. 7. The frequency Fin of the signal CKin is given by the following relationship:

Fin=(p/2ⁿ)Fclk

where Fclk is the clock signal Clk frequency. As has already been said, this signal is affected by a jitter, which can be eliminated by using a phase interpolator.

The synthesizer 140 thus includes a phase interpolator 142 which generates, from the aforementioned signal CKin, an output signal CKout, which is, for instance, the signal CKout shown in the timing diagram in FIG. 11.

The signal CKin is delivered to the input 81 of the module 80 for this purpose. This delivers the values ERR and the signal EN to the phase interpolator 142.

It will be noted that the input 92 of the phase interpolator 142 receives the same clock signal Clk as that which regulates the phase accumulator 141.

Thanks to the invention, the output signal CKout presents a particularly pure spectrum owing to the fact that the spurious frequencies caused by the phase accumulator 141 are strongly attenuated thanks to the phase interpolator 142. The latter is, for example, produced according to the embodiment described above in relation to the diagram in FIG. 8.

FIG. 14, in which the same elements as in FIG. 13 bear the same references, diagrammatically illustrates another example of a digital frequency synthesizer 150. This is an indirect synthesizer, so called in the jargon of the person skilled in the art as it includes feedback means.

The synthesizer 150 includes a phase-locked loop 151 (or PLL). This includes a phase comparator 145 which receives the clock signal Clk at a first input, and of which an output is connected to the control input of a voltage-controlled oscillator 147 (or VCO) via a low-pass filter 146. The output of the oscillator 147 delivers the output signal Sch of the synthesizer. It is connected to a second input of the phase comparator 145 via a frequency divider 148 having a variable ratio.

The synthesizer 150 also includes a phase accumulator 141 such as that described above, which is regulated by the rising edges of the clock signal Clk.

The synthesizer also includes a phase interpolator 142 and an associated control circuit 80, like those described above in relation to the diagram in FIG. 8. The module 80 receives at the input the signal CKin generated by the phase accumulator 141 and delivers the values ERR and the signal EN to the phase interpolator 142. The phase interpolator 142 delivers the signal CKout at the output. It shall be noted that the phase interpolator 142 receives at its input 92 the clock signal Clk that regulates the phase accumulator 141.

The signal CKout is applied to a division ratio control input of the frequency divider 148. The division ratio is, for example, equal to N for a first value of the signal CKout and is equal to N+1 for a second value of the signal CKout, where N is an integer. In this application also, the phase interpolator 142 has the function of eliminating the spurious frequencies from the signal CKin which are caused by the phase accumulator 141 and which otherwise would be found in the spectrum of the synthesizer output signal Sch.

FIG. 15, in which the same elements as in FIG. 13 and FIG. 14 bear the same references, diagrammatically illustrates another example of a digital frequency synthesizer 160. This is also an indirect synthesizer.

The synthesizer includes a PLL reference 161, which comprises a phase comparator 165 whose first input receives an input signal denoted by Ref. The output of the comparator 165 is connected to the control input of a VCO 167, via a low-pass filter 166. The output of the oscillator 167 delivers the output signal Sch of the synthesizer.

A frequency divider by N, where N is a specified integer, receives the signal Sch as input and delivers the clock signal Clk as output. The signal Clk regulates the phase accumulator 141 and is also delivered at the input 92 of the phase interpolator 142. The signal CKin delivered by the phase accumulator 141 is received at the input 81 of the module 80. Its outputs 82 and 83 respectively deliver the values ERR and the signal EN at the inputs 90 and 91 respectively of the phase interpolator 142.

The output 30 of the phase interpolator delivers the signal CKout, which is applied to a second input of the phase comparator 165.

Here again the phase interpolator 142 is used to eliminate the spurious frequencies in the signal Sch at the synthesizer output.

1. Variable phase-shifting circuit comprising:
an input receiving an input signal having a specified oscillation frequency,
an output delivering an output signal having said specified oscillation frequency (Fin) and having a variable phase shift with respect to said input signal,
at least one control input receiving a control signal which controls the phase-shift of said output signal with respect to said input signal,
a synchronized oscillator having at least a synchronization input coupled to said input of the variable phase-shifting circuit, at least an output coupled to said output of the variable phase-shifting circuit, said synchronized oscillator having a variable free-running oscillation frequency controlled by said control signal.

2. The circuit of claim 1, wherein the synchronized oscillator further comprises an astable multivibrator circuit having a first branch and a second branch arranged in parallel between a positive supply terminal and a negative supply terminal or ground, means delivering into the first branch and into the second branch, a respective quiescent current of the same specified value, said quiescent current being controlled by the control signal.

3. The circuit of claim 2, wherein, for each branch, the means delivering a quiescent current into the branch comprises a respective current source arranged in series in the branch, which delivers a current of a specified value, and in wherein the control signal is a current control signal which is added to said current of a specified value.

4. Phase interpolator comprising:
a signal output which delivers an output signal; at least one data input receiving a digital input value coded in P bits, where P is an integer, representing the difference between an actual instant of switching of a pulse of a signal to be interpolated and a desired instant of switching said output signal;
N1 first variable phase-shifting circuits, where N1 is an integer strictly greater than one, each comprising an input which receives an input signal having the frequency of a reference signal, the input signals received by said respective inputs of said N1 variable phase-shifting circuits being respectively phase-shifted by 360°/N1, each variable phase-shifting circuit further comprising a control input receiving a control signal and an output which delivers an output signal corresponding to the signal received at the input phase-shifted based on said control signal, and each variable phase-shifting circuit comprising a synchronized oscillator having at least one synchronization input coupled to said variable phase-shifting circuit input, at least one output coupled to the said output of the variable phase-shifting circuit, said synchronized oscillator having a variable free-running oscillation frequency which is controlled by said control signal;
a multiplexer having N1 inputs which receive the N1 signals delivered by the respective output of the N1 variable phase-shifting circuits and an output which delivers one of the said N1 signals based on the value of a given number Q of the most significant bits of the digital input value, where Q is an integer less than or equal to P.

5. The phase interpolator of claim 4, further comprising a digital/analog converter having P-Q inputs which receive the P-Q least significant bits of the digital input value, and having an output which delivers, based on the value of said P-Q bits, an analog phase-shift correction signal which is delivered at the control input of at least one of the N1 first variable phase-shifting circuits.

6. The phase interpolator of claim 4 wherein the phase-shift correction signal is delivered at the control input of each of the N1 first variable phase-shifting circuits.

7. The phase interpolator of claim 4 further comprising a demultiplexer having an input receiving the phase-shift correction signal, at least N1 outputs respectively coupled to the control input of the N1 first variable phase-shifting circuits, and directing the phase-shift correction signal to the control input of one of the said N1 first variable phase-shifting circuits based on the value of the Q most significant bits of the digital input value.

8. The phase interpolator of claim 4, further comprising a multiphase clock generator comprising:
N1 second variable phase-shifting circuits identical to the N1 first variable phase-shifting circuits, connected in series via their respective inputs and outputs, the input of a first of said N1 second variable phase-shifting circuits receiving the reference signal;
a phase comparator having a first input which receives the reference signal, a second input which is connected to the output of a last one of said N1 second variable phase-shifting circuits, and an output;
a low-pass filter with an input coupled to the output of said phase comparator, and an output;
an adaptation module having an input coupled to the output of said low-pass filter and at least N1 first outputs delivering N1 identical first calibration signals respectively, which are applied to the respective control inputs of said N1 second variable phase-shifting circuits.

9. The phase interpolator of claim 8, wherein the adaptation module of the multiphase clock generator further comprises an N1+1-th output, delivering an N1+1-th calibration signal identical to the calibration signals generated by the N1 first outputs, and coupled to the digital-analog converter.

10. The phase interpolator of claim 4 further comprising calibration means comprising:
N2 third variable phase-shifting circuits identical to the N1 first variable phase-shifting circuits, connected in series via their respective inputs and outputs, the input of a first of said N2 third variable phase-shifting circuits receiving the reference signal;
a phase comparator having a first input which receives the reference signal, a second input which is connected to the output of a last one of said N2 third variable phase-shifting circuits, and an output;
a low-pass filter having an input coupled to the output of said phase comparator, and an output;
an adaptation module having an input coupled to the output of said low-pass filter and at least N2+1 outputs delivering N2+1 identical second calibration signals respectively, among which N2 outputs are coupled to the respective control inputs of said N2 third variable phase-shifting circuits.

11. The phase interpolator of claim 10, wherein the adaptation module of the calibration means includes N2+1 outputs delivering respectively N2+1 identical second calibration signals among which, in addition, the N2+1-th output is coupled to the digital-analog converter so as to provide it with a second reference value.

12. The phase interpolator of claim 10, wherein the adaptation module of the calibration means includes N2+2×N1 outputs delivering respectively N2+2×N1 identical second calibration signals, among which, N1 other outputs are further coupled to the respective control inputs of the N1 second variable phase-shifting circuits of the multiphase clock generator, and among which N1 other outputs are coupled to the respective control inputs of the N1 first variable phase-shifting circuits.

13. The phase interpolator of claim 4, wherein further comprising an input receiving a signal for activating/deactivating the multiplexer, to control the frequency of the output signal with respect to the reference signal frequency.

14. Digital frequency synthesizer comprising a phase accumulator and a phase interpolator coupled to said phase accumulator, wherein said phase interpolator comprises:
a signal output which delivers an output signal;
at least one data input receiving a digital input value coded in P bits, where P is an integer, representing the difference between an actual instant of switching of a pulse of a signal to be interpolated and a desired instant of switching said output signal;
N1 first variable phase-shifting circuits, where N1 is an integer strictly greater than one, each comprising an input which receives an input signal having the frequency of a reference signal, the input signals received by said respective inputs of said N1 variable phase-shifting circuits being respectively phase-shifted by 360°/N1, each variable phase-shifting circuit further comprising a control input receiving a control signal and an output which delivers an output signal corresponding to the signal received at the input phase-shifted based on said control signal, and each variable phase-shifting circuit comprising a synchronized oscillator having at least one synchronization input coupled to said variable phase-shifting circuit input, at least one output coupled to the said output of the variable phase-shifting circuit, said synchronized oscillator having a variable free-running oscillation frequency which is controlled by said control signal;
a multiplexer having N1 inputs which receive the N1 signals delivered by the respective output of the N1 variable phase-shifting circuits and an output which delivers one of the said N1 signals based on the value of a given number Q of the most significant bits of the digital input value, where Q is an integer less than or equal to P.

15. The Digital frequency synthesizer of claim 14, wherein the phase interpolator, further comprises a digital/analog converter having P-Q inputs which receive the P-Q least significant bits of the digital input value, and having an output which delivers, based on the value of said P-Q bits, an analog phase-shift correction signal which is delivered at the control input of at least one of the N1 first available phase-shifting circuits.

16. The Digital frequency synthesizer of claim 14, wherein the phase-shift correction signal is delivered at the control input of each of the N1 first variable phase-shifting circuits.

17. The Digital frequency synthesizer of claim 14, further comprising a demultiplexer having an input receiving the phase-shift correction signal, at least N1 outputs respectively coupled to the control input of the N1 first variable phase-shifting circuits, and directing the phase-shift correction signal to the control input of one of the said N1 first variable phase-shifting circuits based on the value of the Q most significant bits of the digital input value.

18. The Digital frequency synthesize of claim 14, further comprising a multiphase clock generator comprising:
N1 second variable phase-shifting circuits identical to the N1 first variable phase-shifting circuits, connected in series via their respective inputs and outputs, the input of a first of said N1 second variable phase-shifting circuits receiving the reference signal;
a phase comparator having a first input which receives the reference signal, a second input which is connected to the output of a last one of said N1 second variable phase-shifting circuits; and an output;
a low-pass filter with an input coupled to the output of said phase comparator, and an output;
an adaptation module having an input coupled to the output of said low-pass filter and at least N1 first outputs delivering N1 identical first calibration signals respectively, which are applied to the respective control inputs of said N1 second variable phase-shifting circuits.

19. The Digital frequency synthesizer of claim 18, wherein the adaptation module of the multiphase clock generator further comprises an N1+1-th output, delivering an N1+1-th calibration signal identical to the calibration signals generated by the N1 first outputs, and coupled to the digital-analog converter.

20. The Digital frequency synthesize of claim 14 further comprising calibration means comprising:
N2 third variable phase-shifting circuits identical to the N1 first variable phase-shifting circuits, connected in series via their respective inputs and outputs, the input of a first of said N2 third variable phase-shifting circuits receiving the reference signal;
a phase comparator having a first input which receives the reference signal, a second input which is connected to the output of a last one of said N2 third variable phase-shifting circuits, and an output;
a low-pass filter having an input coupled to the output of said phase comparator, and an output;
an adaptation module having an input coupled to the output of said low-pass filter and at least N2+1 outputs delivering N2+1 identical second calibration signals respectively, among which N2 outputs are coupled to the respective control inputs of said N2 third variable phase-shifting circuits.

21. The Digital frequency synthesizer of claim 20, wherein the adaptation module of the calibration means includes N2+1 outputs delivering respectively N2+1 identical second calibration signals among which, in addition, the N2+1-th output is coupled to the digital-analog converter so as to provide it with a second reference value.

22. The Digital frequency synthesizer of claim 20, wherein the adaptation module of the calibration means includes N2+2×N1 outputs delivering respectively N2+2×N1 identical second calibration signals, among which, N1 other outputs are further coupled to the respective control inputs of the N1 second variable phase-shifting circuits of the multiphase clock generator, and among which N1 other outputs are coupled to the respective control inputs of the N1 first variable phase-shifting circuits.

23. The Digital frequency synthesizer of claim 14, wherein further comprising an input receiving a signal for activating/deactivating the multiplexer, to control the frequency of the output signal with respect to the reference signal frequency.
